(19) United States
(12) Patent Application Publication
(10) Pub. No.: US 2018/0143641 A1
(43) Pub. Date: May 24, 2018

(54) MOTION CONTROLLING METHOD FOR AN AUTONOMOUS VEHICLE AND A COMPUTER DEVICE

(71) Applicant: Futurewei Technologies, Inc., Plano, TX (US)

(72) Inventor: Lei RAO, Mountain View, CA (US)

(73) Assignee: Futurewei Technologies, Inc., Plano, TX (US)

(21) Appl. No.: 15/360,243

(22) Filed: Nov. 23, 2016

(51) Int. Cl. G05D 1/02; G05D 1/00

(52) U.S. Cl. CPC G05D 1/0214; G05D 1/0217; G05D 1/0088

(57) ABSTRACT

A computing device implements a motion controlling method for an autonomous vehicle. The computing device obtains information of a first path from a current position of the autonomous vehicle to a first next waypoint. When the computing device identifies a target vehicle occupying the first path according to the information of the first path, the computing device sends the information of the first path to the target vehicle, receives a first cost value sent from the target vehicle, wherein the first cost value indicates amount of resources to be consumed by the target vehicle if the target vehicle needs to adjust movement of the target vehicle to enable the first path. The computing device generates information of a second path that starts with the current position of autonomous vehicle based on the first cost value, then move the autonomous vehicle along the second path.

### TECHNICAL FIELD

The application generally relates to autonomous driving technologies, and more specifically, to a motion controlling system and method for an autonomous vehicle and a computer device.

### BACKGROUND

An “autonomous cars” refers to a vehicle that is capable of sensing its environment and navigating without human input. Autonomous cars can detect surroundings using a variety of techniques and autonomous control systems in the autonomous cars interpret sensory information to identify appropriate navigation paths.

Some unexpected incidents could occur while an autonomous car is in motion. For example, a static obstacle or a moving car could appear in front of the autonomous car when the autonomous car is moving along an identified navigation path, which could result in traffic accidents.

### SUMMARY

It is an object of the present application to provide technologies for controlling the movement of an autonomous vehicle.

In one embodiment, the disclosure includes a motion controlling method for an autonomous vehicle, comprising: obtaining, by a computing device of the autonomous vehicle, information of a first path from a current position of the autonomous vehicle to a first next waypoint, wherein the information of the first path comprises a plurality of poses, each of the plurality of poses includes a position of the autonomous vehicle in the first path, a speed of the autonomous vehicle, and a movement direction of the autonomous vehicle; identifying, by one or more sensors of the autonomous vehicle, a target vehicle occupying the first path according to the information of the first path; sending, by the computing device of the autonomous vehicle, the information of the first path to the target vehicle; receiving, by the computing device of the autonomous vehicle, a first cost value sent from the target vehicle, wherein the first cost value indicates amount of resources to be consumed by the target vehicle if the target vehicle needs to adjust movement of the target vehicle to enable the first path; generating, by the computing device of the autonomous vehicle, information of a second path that starts with the current position of autonomous vehicle based on the first cost value; and moving, by the computing device of the autonomous vehicle, the autonomous vehicle along the second path based on the information of the second path. In this embodiment, when the computing device of the autonomous vehicle identifies another vehicle occupying the first path indicated by motion information, the computing device of the autonomous vehicle communication with the other vehicle to obtain a first cost value from the target vehicle, the first cost value indicates amount of resources to be consumed by the other vehicle if the target vehicle needs to adjust movement of the target vehicle to enable the first path. Based on the first cost value, the computing device of the autonomous vehicle updates the motion information, and moves the autonomous vehicle according to the updated motion information. Thus, the autonomous vehicle may move without crashing with the other vehicle.

In one embodiment, the disclosure includes a communication method for an autonomous vehicle, comprising: receiving, by a computing device of a target vehicle, information of a first path sent from an autonomous vehicle, wherein the information of the first path comprises a plurality of poses, each pose of the plurality of poses includes a position of the autonomous vehicle in the first path, a speed of the autonomous vehicle, and a movement direction of the autonomous vehicle; obtaining, by the computing device of the target vehicle, information of a second path from a current position of the target vehicle to a next waypoint, wherein a closest distance between the first path and the second path is equal to or greater than a distance threshold; calculating, by the computing device of the target vehicle, a cost value that indicates amount of resources to be consumed by the target vehicle if the target vehicle needs to adjust the movement along the second path; sending, by the computing device of the target vehicle, the cost value to the autonomous vehicle. In this embodiment, when the computing device communicated coupled with the target vehicle receives information of a first path sent from an autonomous vehicle, the computing device of the target vehicle calculates a cost value that indicates amount of resources to be consumed by the target vehicle if the target vehicle needs to adjust the movement to enable the first path, then provides the calculated cost value to the autonomous vehicle. The calculated cost value enables the autonomous vehicle to move without crashing with the target vehicle.

In one embodiment, the disclosure includes a computing device for controlling the movement of an autonomous vehicle, the computing device is communicative coupled with the autonomous vehicle, the computing device comprising: a memory comprising instructions; and one or more processors in communication with the memory, wherein the one or more processors execute the instructions to: obtain information of a first path from a current position of the autonomous vehicle to a first next waypoint, wherein the information of the first path comprises a plurality of poses, each of the plurality of poses includes a position of the autonomous vehicle in the first path, a speed of the autonomous vehicle, and a movement direction of the autonomous vehicle; identify a target vehicle occupying the first path according to the information of the first path; send the information of the first path to the target vehicle; receive a first cost value sent from the target vehicle, wherein the first cost value indicates amount of resources to be consumed by the target vehicle if the target vehicle needs to adjust movement of the target vehicle to enable the first path; generate information of a second path that starts with the current position of autonomous vehicle based on the first cost value; and move the autonomous vehicle along the second path based on the information of the second path.

In one embodiment, the disclosure includes a computing device that is communicative coupled with a target vehicle, the computer device comprising: a memory comprising instructions; and one or more processors in communication with the memory, wherein the one or more processors execute the instructions to: receive information of a first path sent from an autonomous vehicle, wherein the information of the first path comprises a plurality of poses, each pose of the plurality of poses includes a position of the autonomous vehicle in the first path, a speed of the autonomous vehicle, and a movement direction of the autonomous vehicle; obtain information of a second path from a current position of the target vehicle to a next waypoint, wherein a closest distance between the first path to the second path is equal to or greater than a distance threshold; calculate a cost value that indicates amount of resources to be consumed by the target vehicle if the target vehicle needs to adjust the movement along the second path; send the cost value to the autonomous vehicle.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 is a diagram illustrating a scenario where two vehicles traveling in the same the direction in a lane.

FIG. 2 is a diagram illustrating a scenario where two vehicles traveling in opposite directions in a narrow lane without any lane markers.

FIG. 3 is a schematic diagram of a computing device and an autonomous vehicle according to an embodiment of the disclosure.

FIG. 4 is a schematic diagram of detailed operations for an application process in accordance with one embodiment of the present disclosure.

FIG. 5 is a flowchart illustrating a motion controlling method used by an autonomous vehicle in accordance with one embodiment of the present disclosure.

FIG. 6 is a diagram illustrating the output information of trajectory planner 320 in accordance with one embodiment of the present disclosure.

FIG. 7 is a diagram illustrating the output information of motion planner 330 in accordance with one embodiment of the present disclosure.

FIG. 8A is a flowchart illustrating the second path generation operation and movement control operation used by an autonomous vehicle in accordance with one embodiment of the present disclosure.

FIG. 8B is a flowchart illustrating the second path generation operation and movement control operation used by an autonomous vehicle in accordance with one embodiment of the present disclosure.

FIG. 9 is a flowchart illustrating the second cost value calculation operation used by an autonomous vehicle in accordance with one embodiment of the present disclosure.

FIG. 10 is a flowchart illustrating a communication method used by a vehicle in accordance with one embodiment of the present disclosure.

FIG. 11 is a diagram illustrating a communication process of two vehicles in accordance with one embodiment of the present disclosure.

FIG. 12 is a diagram illustrating the movements of two vehicles in accordance with one embodiment of the present disclosure.

FIG. 13 is a diagram illustrating a communication process of two vehicles in accordance with one embodiment of the present disclosure.

FIG. 14 is a diagram illustrating the movements of two vehicles in accordance with one embodiment of the present disclosure.

FIG. 15 is a diagram illustrating a communication process of two vehicles in accordance with one embodiment of the present disclosure.

FIG. 16 is a diagram illustrating the movements of two vehicles in accordance with one embodiment of the present disclosure.

### DETAILED DESCRIPTION

In order to make the aforementioned objectives, technical solutions and advantages of the present application more comprehensible, a detailed description is provided below. References will now be made to embodiments, examples of which are illustrated in the accompanying drawings. Insofar as block diagrams, flowcharts, and/or examples contain one or more functions and/or operations, it will be understood by those within the art that each function and/or operation within such block diagrams, flowcharts, or examples can be implemented, individually and/or collectively by a wide range of hardware, software, firmware, or virtually any combination thereof. Also, it will be apparent to one of ordinary skill in the art that the present application may be practiced without these specific details.

Present application provides a computing device for an autonomous vehicle and a motion controlling method for the autonomous vehicle. The computing device is used to prevent the autonomous vehicle from crash with another vehicle in an unexpected scenario. A typical example of the unexpected scenario is a target vehicle occupying an ongoing path of the autonomous vehicle. The target vehicle in present embodiment refers to another vehicle that can communicate with the autonomous vehicle in a proper manner. The target vehicle may be but not necessary to be another autonomous vehicle.

When the computing device identifies a target vehicle occupying an ongoing path of the autonomous vehicle, the computing device sends information of the path to the target vehicle, where the information indicates the ongoing path of the autonomous vehicle. The computing device receives a cost value from the target vehicle, where the cost value indicates resource quantity that will be consumed by the target vehicle if the target vehicle needs to adjust the movement of the target vehicle to enable the path. The computing device further updates the motion information according to the cost value and moves the autonomous vehicle according to the updated motion information.

FIG. 1 is a diagram showing a scenario where two vehicles traveling in the same the direction in a lane. Both vehicle 101 and vehicle 102 are traveling in lane 100, each of vehicles 101 and 102 is equipped with a respective computing device. As shown in FIG. 1, vehicle 101 will turn right on an upcoming cross road and vehicle 102 will keep going straight, and the width of lane 100 is not wide enough to permit vehicle 101 and vehicle 102 passing through each other side by side. When vehicle 101 that is traveling in front of vehicle 102 stops for some reason on lane 100, the computing device in vehicle 101 and vehicle 102 may negotiate and update the motion information with each other.

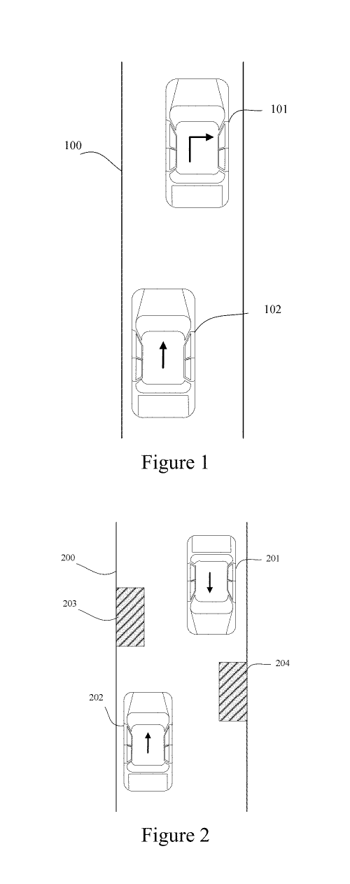

FIG. 2 is a diagram showing a scenario where two vehicles traveling in opposite directions in a narrow lane without any lane markers. Both vehicle 201 and vehicle 202 are equipped with respective computing devices. As shown in FIG. 2, in addition to vehicles 201 and 202, two static obstacles 203 and 204 are on lane 200. Obstacle 203 is located in the front of vehicle 202 and next to vehicle 201, and obstacle 204 is located in the front of vehicle 201 and next to vehicle 202. As a result, vehicle 201 and vehicle 202 may not pass through each other side by side from their present locations in lane 200. In order to bypass obstacles 203 and 204 on lane 200, vehicle 201 and vehicle 202 may use their respectively equipped computing devices to negotiate and update the motion information with each other.

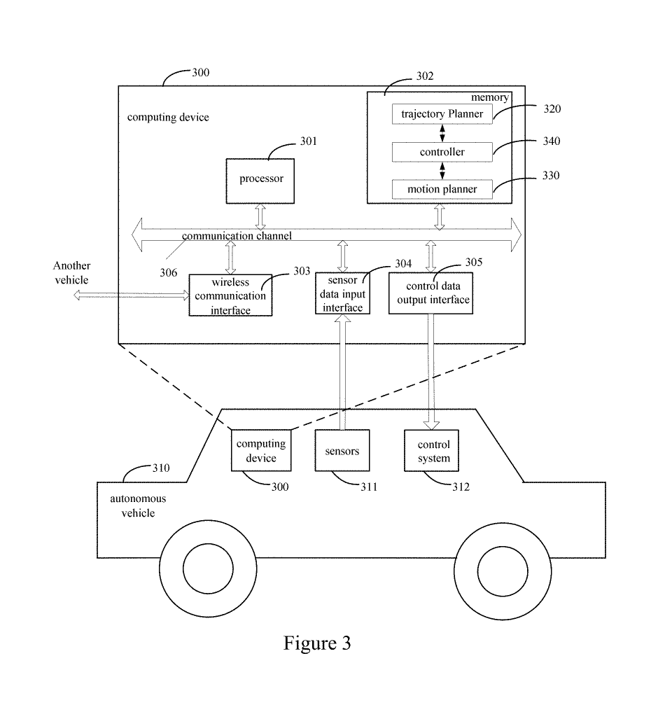

FIG. 3 is a block diagram of an exemplary computing device 300 that is equipped in or communicatively coupled with an autonomous vehicle 310 in accordance with one embodiment of the present disclosure. Autonomous vehicle 310 may be any type of vehicle including, but not limited to, cars, trucks, motorcycles, busses, recreational vehicles, amusement park vehicles, farm equipment, construction equipment, trams, and golf carts.

As shown in FIG. 3, computing device 300 is coupled with a set of sensors 311. Sensors 311 may include, but not limited to, Cameras, RADAR units, Microphones, Laser units, etc. Sensors 311 may also include a geographic location device, such as a Global Positioning System (GPS) receiver used for determining the latitude, longitude, and/or altitude position of autonomous vehicle 310. Other location device such as laser-based localization device, inertial-aided GPS, or camera-based localization device coupled with sensors 311 may also be used to identify the location of autonomous vehicle 310. The location information of autonomous vehicle 310 may include an absolute geographical location information, such as latitude, and longitude, as well as relative location information, such as location relative to other vehicles immediately around.

Sensors 311 may also provide current environment information to computing device 300. For example, when an unexpected obstacle appears in front of autonomous vehicle 310, sensors 311 collect current environment information related to the unexpected obstacle and provide the collected environment information to computing device 300. The collected environment information may include the size of the obstacle, the moving direction of the obstacle, and the speed of the obstacle.

Computing device 300 is coupled with control system 312 of autonomous vehicle 310 through a cable. Computing device 300 may be powered by a storage battery or a solar battery of autonomous vehicle 300. Computing device 300 implements a motion controlling method to guide autonomous vehicle 310 move along a path and to provide motion information (e.g., path information including poses) to control system 312 of autonomous vehicle 310. Control system 312 of autonomous vehicle 310 controls the driving of autonomous vehicle 310 according to the received motion information.

As shown in FIG. 3, computing device 300 may include processor 301, memory 302, wireless communication interface 303, sensor data input interface 304, control data output interface 305, and communication channel 306. Processor 301, memory 302, wireless communication interface 303, sensor data input interface 304, and control data output interface 305 are communicatively coupled with each other through communication channel 306. Communication channel 306 includes, but not limited to, a bus support FlexRay, Controller Area Network (CAN), and Shared cable Ethernet. Computing device 300 may also include other devices typically present in a general purpose computer.

Sensor data input interface 304 is coupled with sensors 311 of autonomous vehicle 310 and configured to receive location information generated by sensors 311. Control data output interface 305 is coupled with control system 312 of autonomous vehicle 310 and configured to provide motion information generated by computing device 300 to control system 312. Control system 312 controls the moving direction and the speed of autonomous vehicle 310 according to the received the motion information generated by computing device 300.

Wireless communication interface 303 is configured to communicate with other vehicles using wireless signals. The wireless signals transmitted among wireless communication interface 303 and other vehicles are carried by 802.11p protocol. The 802.11p protocol is developed for a U.S. Department of Transportation project, namely, dedicated short-range communications (DSRC). Wireless communication interface 240 may also use other protocol suites, for example, Long-Term Evolution (LTE), or 5th generation wireless systems to transmit wireless signals.

Processor 301 may be any conventional one or more processors, including Reduced Instruction Set Computing (RISC) processors, Complex Instruction Set Computing (CISC) processors, or combinations of the foregoing. Alternatively, processor 220 may be a dedicated device such as an applicant-specific integrated circuit (ASIC). Processor 301 is configured to execute instructions stored in memory 302.

Memory 302 may store information accessible by processor 301, such as instructions and data that may be executed or otherwise used by processor 301. Memory 302 may be of any type of memory operative to store information accessible by processor 301, including a computer-readable medium, or other medium that stores data that may be read with the aid of an electronic device. Examples of memory 302 include, but are not limited, a hard-drive, a memory card, read-only memory (ROM), random-access memory (RAM), digital video disc (DVD), or other optical disks, as well as other write-capable and read-only memories. Systems and methods may include different combinations of the foregoing, whereby different portions of the instructions and data are stored on different types of media.

The instructions stored in memory 302 may be any set of instructions executed directly, such as machine code, or indirectly, such as scripts by processor 301. For example, the instructions may be stored as computer code on the computer-readable medium. In that regard, the terms “instructions” and “programs” may be used interchangeably herein. The instructions may be stored in object code format for direct processing by processor 301, or in any other computer language including scripts or collections of independent source code modules that are interpreted on demand or compiled in advance. Functions, methods and routines of the instructions are explained in more detail below.

FIG. 3 further illustrates a logical function block diagram of an application process that is generated by processor 302 when executing the instructions stored in memory 301. The application process includes at least three functional modules, namely, a trajectory planner 320, a motion planner 330, and a controller 340.

Motion information generated by computing device 300 includes two kinds of motion information, namely, high level motion information and low level motion information. The motion information indicates ongoing movement for autonomous vehicle 310.

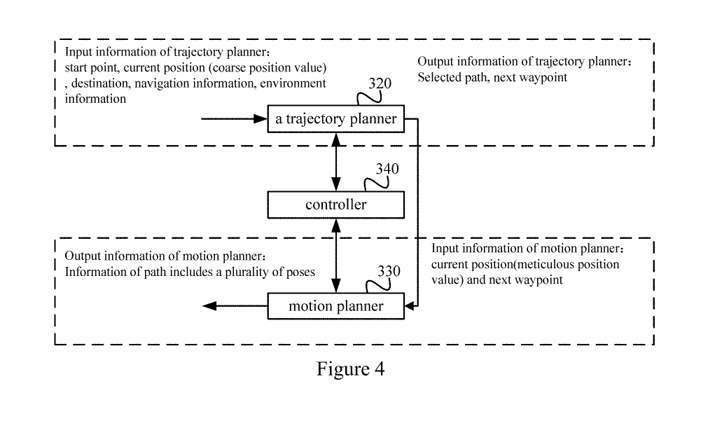

FIG. 4 is a diagram showing the detailed operations for the application process in accordance with one embodiment of the present disclosure. The application process includes trajectory planner 320, motion planner 330, and controller 340 in memory 302 of computing device 300.

Trajectory planner 320 is configured to generate high level motion information for autonomous vehicle 310 based on the input information received and a pre-set trajectory generation algorithm. The input information received by trajectory planner 320 includes a start point, a current position, a destination, navigation information, and environment information. The navigation information includes map data. The environment information includes traffic statistical data, and static obstacle data. The trajectory generation algorithm includes Dynamic Programming (DP) method. The DP method may be used by trajectory planner 320 to generate multiple possible paths according to the input information. Each path generated by trajectory planner 320 includes a sequence of waypoints. Each waypoint has a position value that is expressed by p(x, y). The symbol x in p(x, y) indicates a value in horizontal axis of the map, and the symbol y in p(x, y) indicates a value in vertical axis of the map. A distance between two neighboring waypoints is about 50 meters to 150 meters.

Some research gives some demonstrations about generating high level motion information according to DP method. FIG. 4 is an example of the paths provided by Trajectory Planner 310.

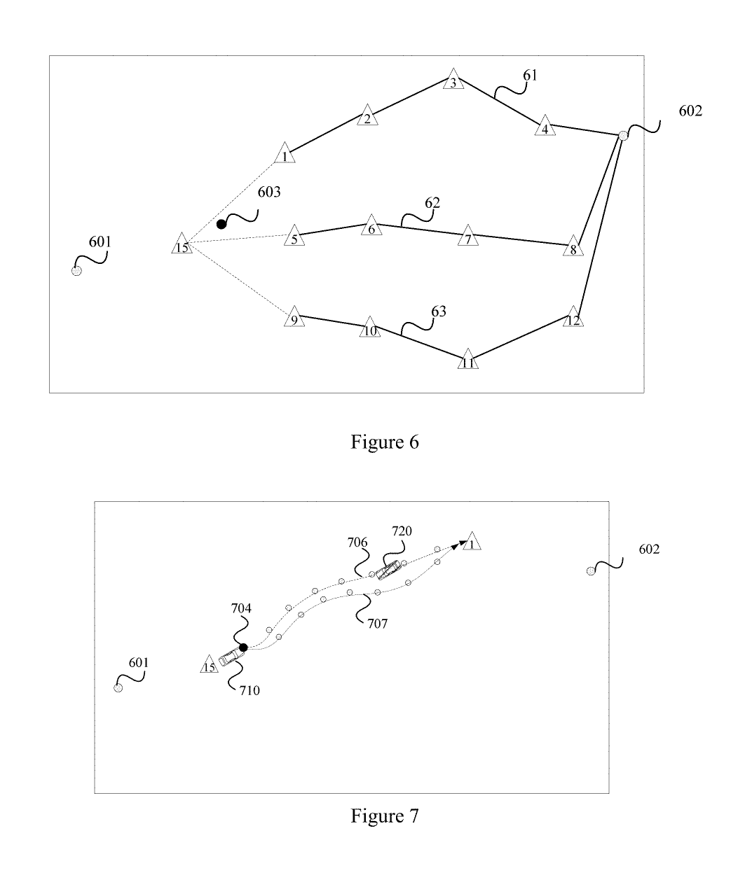

In one embodiment, trajectory planner 320 may communicate with controller 340 multiple times when autonomous vehicle 310 moves from the start point to the destination. In this situation, the start point in the input information is replaced by the current position of autonomous vehicle 310. The current position of autonomous vehicle 310 is indicated by a coarse position value provided by sensors 311. The coarse position value indicates a position located in a segment constructed by two consecutive waypoints in a map. After controller 340 inputs coarse position value indicating the current position of autonomous vehicle 310 to trajectory planner 320, trajectory planner 320 may calculate multiple possible paths for each coarse position value received based on other input constraint, e.g., static obstacle, and each of the multiple possible paths starts with a waypoint close to the current position and ends at the destination. Then trajectory planner 320 selects a path from the multiple possible paths according to the pre-set policy. Trajectory planner 320 further determines a waypoint that is closest to the current position and on the selected path. Trajectory planner 320 outputs the selected path and the determined waypoint as the high level motion information. FIG. 6 is a diagram illustrating the output information of trajectory planner 320, which will be discussed below.

The waypoint closest to the current position and on the selected path is called as a “next waypoint”. The next waypoint is regarded as a destination for autonomous vehicle 310 to arrive in a shortest controlling period. In other words, the next waypoint is a destination for current low level path planning. In one embodiment, the next waypoint may be used by motion Planner 330 as input for generating low level motion information. The low level path planning is in order to provide low level motion information for an autonomous vehicle to arrive the next waypoint.

Motion planner 330 is configured to generate low level motion information for autonomous vehicle 310 based on the meticulous position value provided by sensors 311, the next waypoint generated by trajectory planner 320, and the pre-set motion generation algorithm. Sometimes the input information received by motion planner 330 further includes obstacle information provided by sensors 311. The obstacle includes static obstacle or moving obstacle. When the obstacle is a static obstacle, the obstacle information includes meticulous position information, sharp, size, etc. When the obstacle is a moving obstacle, such as a vehicle on the road, the obstacle information includes meticulous position information, heading value, speed value, etc. The pre-set motion generation algorithm includes Hybrid A*, A*, D* and R*. Some research demonstrates how to generate low level motion information according to these algorithms.

For a set of input information, motion planner 330 calculates the path information based on a current position of autonomous vehicle 310 and the next waypoint received. The path information includes a plurality of poses, which enables autonomous vehicle 300 to move from the position indicated by the meticulous current position value of autonomous vehicle 300 to the next waypoint received step by step. The data structure of each poses is expressed as vector P(p(x, y), s(x, y), h(θ). The p(x, y) in vector P indicates a position value in the path, for example, the symbol x in p(x, y) indicates a value in the horizontal axis of the map, and the symbol y in p(x, y) indicates a value in the vertical axis of the map. The s(x, y) in vector P indicates a speed of autonomous vehicle 300 in the horizontal axis and the vertical axis, respectively. The h(θ)in vector P indicates the movement direction of autonomous vehicle 310. Motion planner 330 outputs the path information that includes a plurality of poses as the low level motion information, which will be discussed in details with respect to the embodiment description for FIG. 7.

In one embodiment, in order to control the movement of autonomous vehicle 310 accurately, a number of poses output by motion planner 330 is determined based on the approximate moving speed of autonomous vehicle 310 and a preset requirement. For example, the preset requirement may be that 10 poses are required for each second movement of autonomous vehicle 300. In one example, the distance between the current position indicated by the meticulous current position value of autonomous vehicle 310 and the next waypoint generated by trajectory planner 320 is about 100 meters, and the approximate moving speed of autonomous vehicle 310 is 36 km/h (10 m/s). Thus, autonomous vehicle 310 need to speed 10 s to move from the current position to the next waypoint generated by trajectory planner 320; motion planner 320 needs output 100 poses.

Controller 340 is configured to received data sent from sensors 311, determine whether a target vehicle is on a route of autonomous vehicle 310 to a next waypoint according to the data sent from sensors 311 and pre-set algorithms. Controller 340 is further configured to communicate with trajectory planner 320 and motion planner 330 based on different input information and different road condition. Please refer to the following embodiment for more details. Controller 340 may be further configured to communicate with the target vehicle through wireless communication interface 303.

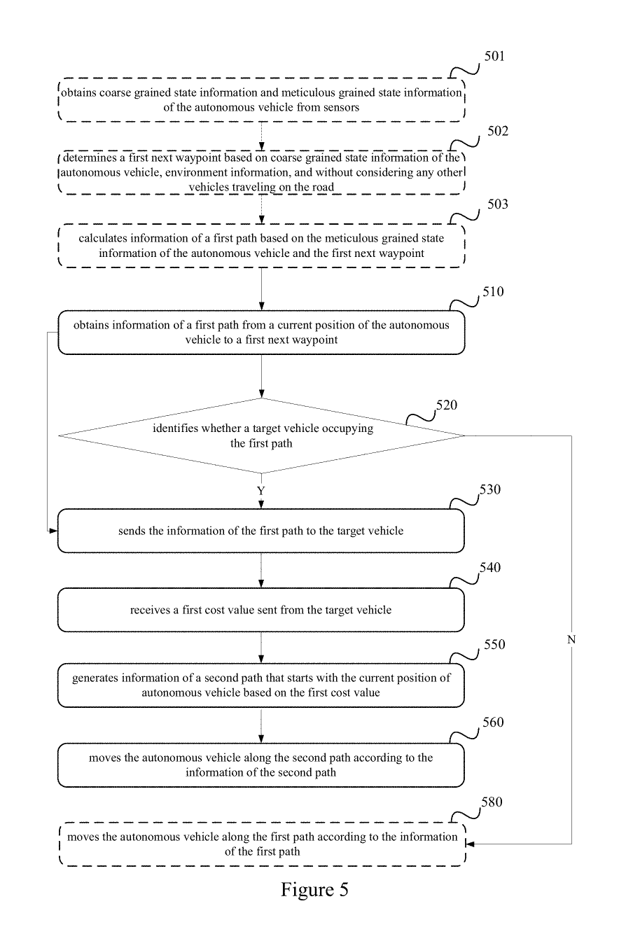

FIG. 5 is a simplified process flow diagram illustrating a motion controlling method used by an autonomous vehicle in accordance with one embodiment of the present disclosure. The motion controlling method is implemented by a computing device, e.g., computing device 300 as illustrated in FIG. 3. The motion controlling method includes following operations.

In operation 510, the computing device obtains information of a first path from a current position of the autonomous vehicle to a first next waypoint. The information of the first path comprises a plurality of poses. Each pose of the plurality of poses includes a position of the autonomous vehicle in the first path, a speed of the autonomous vehicle, and a movement direction of the autonomous vehicle.

In one embodiment, the computing device may perform operations 501˜503 before operation 510.

In operation 501, the computing device obtains coarse grained state information and meticulous grained state information of the autonomous vehicle from sensors, e.g., computing device 300 obtains coarse grained state information and meticulous grained state information of autonomous vehicle 310 from sensors 311 as illustrated in FIG. 3. The coarse grained state information includes a coarse current position value of the autonomous vehicle. The coarse current position value indicates a position that locates in a segment constructed by two waypoints. Waypoints are marked in a map in advance. A waypoint may be marked at a lane marker, a building or a view spot. A sequence of waypoints constructs a path from a start point of the autonomous vehicle to a destination of the autonomous vehicle.

The meticulous grained state information includes meticulous current position value of the autonomous vehicle. Sometimes, the meticulous grained state information also includes a heading value that indicates the moving direction of the autonomous vehicle

In operation 502, the computing device determines a first next waypoint based on coarse grained state information of the autonomous vehicle, environment information, without considering any other vehicles travelling on the road. The first next waypoint provides a coarse position target for the autonomous vehicle to arrive at in a shortest controlling period. The first next waypoint could be a waypoint closest to the autonomous vehicle on the path from a current position indicated by the coarse position value of the autonomous vehicle to the destination. Sometimes, there are multiple possible paths, each of which starts from the current position to the destination. A waypoint that is the closest to the autonomous vehicle on one of the possible paths can be regarded as a candidate next waypoint. In one embodiment, trajectory planner 320 selects a waypoint from all of the candidate next waypoints based on the pre-set selection policy, e.g., the minimize time cost selection policy.

FIG. 6 is a simplified diagram illustrating an example of next waypoint determination process in accordance with one embodiment of the present disclosure. As shown, blank spot 601 stands for a start point and blank spot 602 stands for a destination for an autonomous vehicle. Black spot 603 represents the current position of the autonomous vehicle, which may be indicated by the coarse position value of the autonomous vehicle. The triangles in FIG. 6 represent waypoints that are preset in a map. The current position of the autonomous vehicle is located on a segment constructed by two waypoints in the map. For example, black spot 603 is on a segment constructed by waypoint 15 and waypoint 1, the black spot 603 may also be considered on a segment constructed by waypoint 15 and waypoint 5 or a segment constructed by waypoint 15 and waypoint 9.

At the beginning of the motion planning for the autonomous vehicle, trajectory planner, such as trajectory planner 320 in FIG. 3, takes a start point of the autonomous vehicle as the input current position, such as blank spot 601. With the movement of the autonomous vehicle and the changing environment information, trajectory planner 320 can communicate with controller 330 to update high level motion information for autonomous vehicle 310. Trajectory planner 320 may generate multiple possible paths based on the current position of the autonomous vehicle and then select an optimism path. A path selected based on the current position of the autonomous vehicle may be different from a path selected based on the start point of the autonomous vehicle.

Referring back to FIG. 6, a trajectory planner, such as trajectory planner 320 in FIG. 3, determines that there are three lanes, namely lane 61, lane 62, and lane 63, each of which starts with a waypoint close to the black spot 603 and ends with the blank spot 602. These paths are determined according to coarse current position value of the autonomous vehicle and the coarse heading value included in the coarse grained state information, and the map data. Waypoint 1 is the closest waypoint on lane 61 to the autonomous vehicle. Waypoint 5 is the closest waypoint on lane 62 to the autonomous vehicle. Waypoint 9 is the closest waypoint on lane 63 to the autonomous vehicle.

Trajectory planner 320 calculates the time the autonomous vehicle will spend on when moving from current position 603 to destination 602 along every lane. For example, trajectory planner 320 may select lane 61 because lane 61 will cost the autonomous vehicle less time. Trajectory planner 320 determines waypoint 1 on lane 61 is the first next waypoint.

In operation 503, the computing device, e.g., computing device 300 in FIG. 3, calculates information of a first path based on the meticulous grained state information of the autonomous vehicle and the first next waypoint. The calculated first path enables the autonomous vehicle to move from the current position indicated by the meticulous position value of the autonomous vehicle to the first next waypoint. The information of the first path includes a plurality of poses and each of the poses in the information of the first path has a position value. Referring to FIG. 7, FIG. 7 is a diagram illustrating the output information of trajectory planner 320 in accordance with one embodiment of the present disclosure. Vehicle 710 in FIG. 7 stands for an autonomous vehicle and vehicle 720 stands for another vehicle on lane 706. Blank spot 601 stands for the start point and blank spot 602 stands for the destination. Black spot 704 stands for the current position indicated by the meticulous position value of the autonomous vehicle. Motion planner, e.g., motion planner 330 in FIG. 3, calculates multiple paths from black spot 704 to the first next waypoint 1, such as path 706 and path 707. Every circular dot in FIG. 7 stands for a pose in paths output by motion planner 330. Then, motion planner 330 calculates the time respectively to be consumed by the autonomous vehicle when moving along path 706 and path 707. Based on the calculated time, motion planner 330 selects a path that will consume the least amount of time as the output of motion planner 320, e.g., path 706. Motion planner 330 may select path as the output according to different policies.

In operation 520, the computing device identifies whether a target vehicle (e.g., vehicle 720) occupying the first path (e.g., path 706), using the information provided by sensors 311. When the computing device identifies a target vehicle occupying the first path, in other words the target vehicle is on a route of the autonomous vehicle to the first next waypoint, the computing device implements operation 530. Otherwise, the computing device implements operation 580, when the computing device identifies no target vehicle is on a route of the autonomous vehicle to the first next waypoint. In operation 580, the computing device moves the autonomous vehicle along the first path according to the information of the first path.

In reality, it may happen that more than one target vehicles occupying the first path. In this situation, the computing device selects a target vehicle that is closest to the autonomous vehicle, and regards the closest target vehicle as the communication object in the following operations.

In operation 530, the computing device may send the information of the first path to the target vehicle. Alternatively, the computing device may send a request message to the target vehicle through a wireless communication interface of the computing device, e.g., wireless communication interface 303 in FIG. 3, where the request message carries the information of the first path.

In operation 540, the computing device receives a first cost value sent from the target vehicle, where the first cost value indicates the amount of resources to be consumed by the target vehicle if the target vehicle needs to adjust the movement of the target vehicle to enable the first path (i.e., clear the first path so that the autonomous vehicle can move along the first path without crashing with the target vehicle). Alternatively, the computing device may receive a response message sent from the target vehicle through the communication interface, where the response message carries a first cost value.

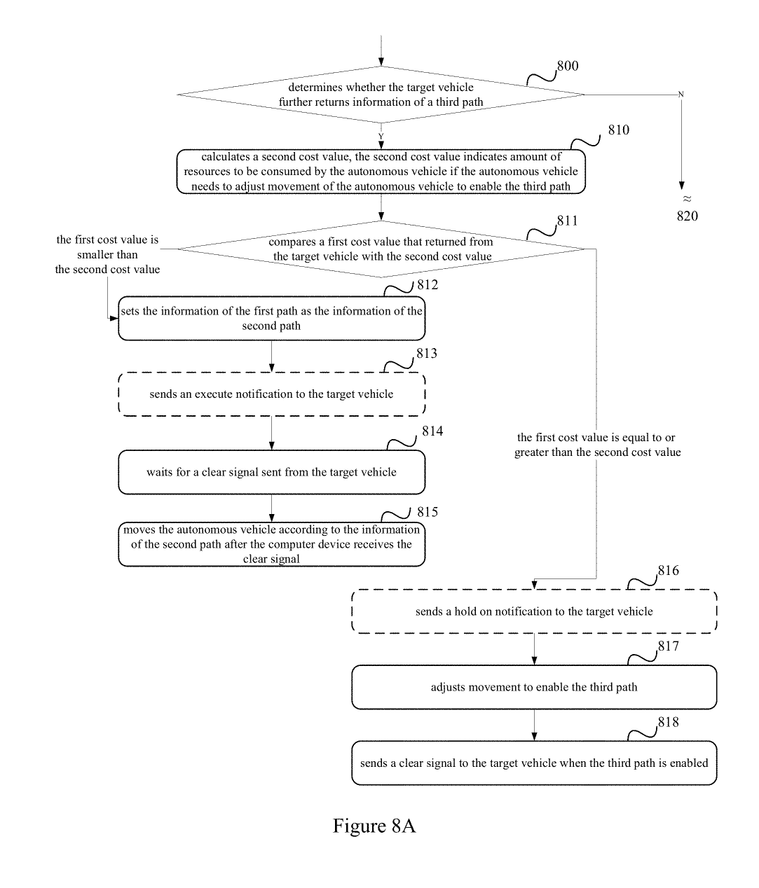

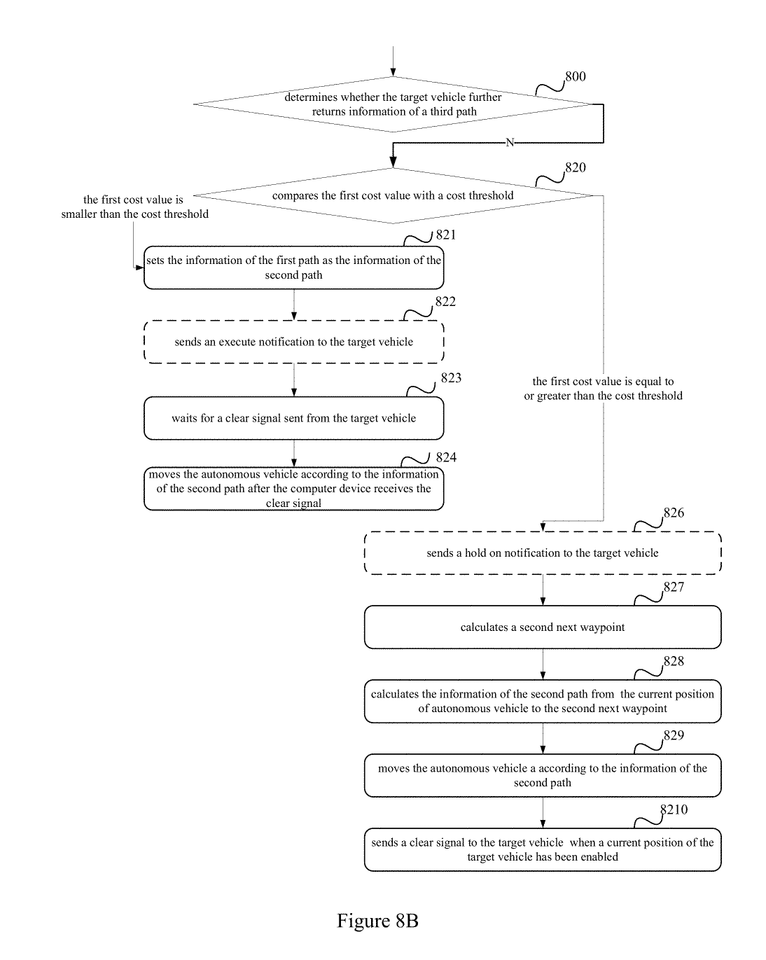

In operation 550, the computing device generates information of a second path that starts with the current position of autonomous vehicle based on the first cost value. For example, when path 706 in FIG. 7 stands for the first path, the path 707 stands for the second path. Actually, there are many possible processes in operation 550 that will be illustrated in details with respect to the descriptions for FIG. 8A and FIG. 8B.

In operation 560, the computing device moves the autonomous vehicle along the second path according to the information of the second path.

In operation 560 or 580, the computing device, e.g., computing device 300 in FIG. 3, provides the information of the second path or the information of the first path to autonomous vehicle 310 through control data output interface 305, then control system 312 in autonomous vehicle 310 adjusts the movement direction and speed of autonomous vehicle 310 according to the information received.

FIG. 8A and FIG. 8B is a flow diagram illustrating the second path generation operation and movement control operation used by an autonomous vehicle in accordance with one embodiment of the present disclosure. The operations as illustrated by FIG. 8A and FIG. 8A are implemented by a computing device, e.g., computing device 300 as illustrated in FIG. 3, in case the computing device detects a target vehicle is on a route to the first next waypoint, and the computing device receives a first cost value returned from the target vehicle.

According to FIG. 8A, in operation 800, the computing device determines whether the target vehicle further returns information of a third path. The information of the third path is the current low level motion information of the target vehicle. In other words, the information of the third path indicates the ongoing movement plan of target vehicle. The third path starts with a current position of the target vehicle and ends with the next way point of the target vehicle. The target vehicle may calculates the information of the third path using the similar method as described in above embodiments, such as the embodiment description for operations 501˜503 of the FIG. 5, FIG. 6 and FIG. 7.

Alternatively, the target vehicle may carry the information of a third path and the first cost value in a same response message. In this condition, the computing device interprets the response message received and obtains the first cost value and information of a third path carried in the response message.

Alternatively, the target vehicle may send the first cost value and the information of a third path respectively using different response messages. In this condition, when the computing device receives multiple response messages sent from a same target vehicle in a set time period, for example, in 0.05 second. Then computing device interprets the multiple response messages received in the set time period from a same target vehicle, then obtains the first cost value and information of a third path carried in these response messages. When the computing device only receives one response message in the set time period, the computing device determines that the target vehicle does not return the information of a third path, and then obtains the first cost value from the response message.

If the response message further carries the information of the third path, or the additional message carries the information of the third path, the method will proceed to operation 810. Otherwise, if the response message does not carry information of the third path or the computing device does not receive the additional message in the set time period, the method will proceed to operation 820, which will be described in detail with respected to FIG. 8B.

In operation 810, the computing device calculates a second cost value, according to the meticulous grained state information of the autonomous vehicle and the information of the third path. The second cost value indicates amount of resources to be consumed by the autonomous vehicle if the autonomous vehicle needs to adjust movement of the autonomous vehicle to enable the third path.

In this operation, the computing device may firstly attempt to obtain information of a forth path. The forth path starts with the current position of the autonomous vehicle and ends with the first next waypoint. If the autonomous vehicle moves along the forth path, the third path will be enabled and the autonomous vehicle will arrive at the first next waypoint step by step.

When the forth path exist, then the computing device calculates the second cost value according to the forth path.

When the forth path does not exist, the second cost value may be set as a pre-set value that is an extreme great value, represent as MAX. MAX may be defined according to engineering experience and depends on a maximum period length that the autonomous vehicle can wait and a price per time unit. MAX is a result of the maximum period length multiplies the price per time unit. MAX may be a result of the N multiplies a cost threshold; N is a natural number greater than 2.

When the second cost is greater than MAX, it means the cost for the autonomous vehicle adjusting the movement to enable the third path is too expensive, for example, the autonomous vehicle will detour a long distance or spend too long time for enabling the third path. In this situation, the autonomous vehicle may wait for the target vehicle adjusting the movement to enable the first path.

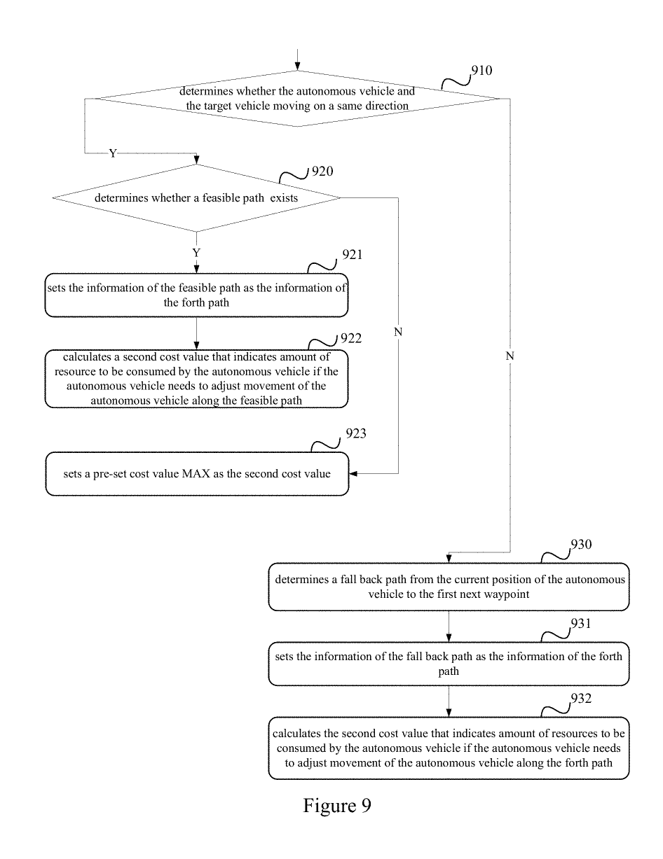

The detail about how computing device to determine the forth path and how to calculate the second cost value will be discussed in detail with respect to the embodiment description for FIG. 9.

In operation 811, the computing device compares a first cost value that returned from the target vehicle with the second cost value calculated in operation 810. If the first cost value is smaller than the second cost value, the computing device implements a sub flow constructed by operations 812 to 815. Otherwise, if the first cost value is equal to or greater than the second cost value, the computing device implements a sub flow constructed by operations 816 to 818.

In operation 812, the computing device sets the information of the first path as the information of the second path.

Besides generating the information of the second path, another important issue of present embodiment is how to determine the movement order of the two vehicles. The present embodiment provides a negotiation manner for the autonomous vehicle and target vehicle, to determine the movement order. It is necessary to point out that a synchronization mechanism used by the autonomous vehicle and the target vehicle for negotiating an execution sequence not limited to the hold on notification and execute notification described in present embodiment. For example, the autonomous vehicle and the target vehicle also can use token occupying mechanism for negotiating the execution sequence of the two vehicles.

Alternatively, in operation 813, the computing device sends an execute notification to the target vehicle. The execute notification is used to notify the target vehicle to move according to the information of the third path and send a clear signal when the first path has been enabled according to the movement of the target vehicle.

In operation 814, the computing device waits for a clear signal sent from the target vehicle. The clear signal indicates the first path has been enabled. When the target vehicle has adjusted movement to enable the first path can be implemented by the autonomous vehicle without crash, the target vehicle will sent the clear signal to the autonomous vehicle.

In operation 815, the computing device moves the autonomous vehicle according to the information of the second path after the computing device receives the clear signal.

Alternatively, in operation 816, the computing device sends a hold on notification to the target vehicle. The hold on notification is used to indicate the target vehicle to stay on its current position and continue to move until receiving a clear signal sent from the computing device. The clear signal sent from the computing device is used to indicate the third path has been enabled.

In operation 817, the computing device adjusts the movement to enable the third path. In present application, the term “enable the path” describes that the lane indicated by the information of the path has been cleared. When the third path has been enabled, the target vehicle can move along the third path according to the information of the third path without crashing with the target vehicle.

In this operation, the computing device may set the information of the forth path as the information of the second path. Thus, the computing device generates the information of the second path. Then the computing device moves the autonomous vehicle along the second path according to the second path in order to enable the third path.

In operation 818, the computing device sends a clear signal to the target vehicle when the third path is enabled.

The computing device updates the current position of the autonomous vehicle (e.g., autonomous vehicle 310 in FIG. 3) continually during the movement process according to the location information input by sensors, e.g., sensors 311 in FIG. 3, and compares the current position of the autonomous vehicle with the information of the third path. When the computing device determines that the autonomous vehicle arrive at a particular position where the third path is enabled, the computing device sends the clear signal to the target vehicle. Alternatively, when the autonomous vehicle and the target vehicle moves on a opposite direction, the computing device may controls the autonomous vehicle stay at the particular for some second to let the target vehicle passing by the autonomous vehicle. In this way, the driving safety is improved.

In operation 820, the computing device compares the first cost value with a cost threshold. If the first cost value is smaller than the cost threshold, the computing device implements a sub flow constructed by operations 821 to 824. If the first cost value is equal to or greater than the cost threshold, the computing device implements a sub flow constructed by operations 826 to 8210.

In operation 821, the computing device sets the information of the first path as the information of the second path. Thus, the computing device generates the information of the second path.

Alternatively, in operation 822, the computing device sends an execute notification to the target vehicle.

In operation 823, the computing device waits for a clear signal sent from the target vehicle.

In operation 824, the computing device moves the autonomous vehicle along the second path according to the information of the second path after the computing device receives the clear signal.

Alternatively, in operation 826, the computing device sends a hold on notification to the target vehicle.

In operation 827, the computing device calculates a second next waypoint based on the coarse grained state information of the autonomous vehicle and environment information and considering the target vehicle as a static obstacle on the road. The second next waypoint provides a coarse position target for the autonomous vehicle to arrive at in a shortest controlling period.

Alternatively, in this situation, controller 340 in FIG. 4 communicates with trajectory planner 320 of FIG. 4 again for determine the second next waypoint. Trajectory planner 320 may select another possible lane, and determine the closest waypoint on the selected lane as the second next waypoint. Referring back to FIG. 6, waypoint 1 is the first next waypoint, in this operation, trajectory planner 320 selects lane 62, and determines waypoint 5 on lane 62 as the second next waypoint.

In operation 828, the computing device calculates the information of the second path based on the meticulous grained state information of the autonomous vehicle, and the second next waypoint. The second path starts with the current position of autonomous vehicle and ends with the second next waypoint.

In operation 829, the computing device moves the autonomous vehicle along the second path according to the information of the second path.

In operation 8210, the computing device sends a clear signal to the target vehicle when the third path is enabled. The clear signal indicates a current position of the target vehicle has been enabled.

Alternatively, the computing device may send the notifications or signals, and receive the notifications or signals through a wireless communication interface of the computing device, e.g., wireless communication interface 303 in FIG. 3.

FIG. 9 is a flow diagram illustrating the second cost value calculation operation used by an autonomous vehicle in accordance with one embodiment of the present disclosure. The operations illustrated by FIG. 9 are implemented by a computing device, e.g., computing device 300 as illustrated in FIG. 3.

In operation 910, the computing device determine whether the autonomous vehicle and the target vehicle moving on a same direction.

There are multiple methods for determining whether the autonomous vehicle and the target vehicle moving on a same direction. For example, the computing device may determine whether the autonomous vehicle and the target vehicle moving on a same direction according to the meticulous grained state information of the vehicles. The meticulous grained state information comprises meticulous current position value and heading value of the vehicle. As discussed with respect to the embodiment description for the operation 501, the computing device obtains meticulous grained state information of the computing device from sensors 311 as illustrated in FIG. 3. Alternatively, the computing device obtains meticulous grained state information of the target vehicle using any one of the following two manners.

Manner A, the computing device obtains meticulous grained state information of the target vehicle based on detection data generated by the sensors, e.g., sensors 311 in FIG. 3.

Manner B, the computing device obtains meticulous grained state information of the target vehicle through an active message sent by the target vehicle. The target vehicle broadcasts the active message to other vehicles periodicity. The vehicle that near to the target vehicle, for example the distance between the vehicle and the target vehicle is less than 100 meters, may receive the active message. The active message carries the meticulous grained state information of the target vehicle. The computing device receives the active message sent from the target vehicle. The computing device interprets the active message and obtains the meticulous grained state information carried in the active message.

Then, the computing device determines whether the autonomous vehicle and the target vehicle moving on a same direction according to the difference value between the heading value comprised the meticulous grained state information of the autonomous vehicle and the heading value comprised the meticulous grained state information of the target vehicle. For example, the computing device determines the autonomous vehicle and the target vehicle moving on a same direction when the difference value is smaller than 90 degree; the computing device determines the autonomous vehicle and the target vehicle moving on a same direction when the difference value is greater than 90 degree.

Alternatively, the computing device may determines whether the autonomous vehicle and the target vehicle moving on a same direction based on the meticulous grained state information of the autonomous vehicle and the information of the third path sent from the target vehicle. In this situation, the computing device does not need to obtain meticulous grained state information of a target vehicle. Firstly, the computing device selects a pose whose position is closest to the current position of the autonomous vehicle from the information of the third path. In other words, the distance between the selected pose to the autonomous vehicle is smaller than a safety distance. Then, the computing device determines whether the autonomous vehicle and the target vehicle moving on a same direction according to the difference value between the heading value comprised the meticulous grained state information of the autonomous vehicle and the heading value of the selected pose.

If the autonomous vehicle and the target vehicle moving on a same direction, the computing device implements a sub flow constructed by operations 920 to 923. If the autonomous vehicle and the target vehicle moving on a different direction, the computing device implements a sub flow constructed by operations 930 to 932.

In operation 920, the computing device determines whether a feasible path from the current position of the autonomous vehicle to the first next waypoint exists. The feasible path meets two following requirements.

Requirement 1, the feasible path does not include opposite direction movement. Opposite direction movement means movement along a direction whose degree differs to the heading value comprised the meticulous grained state information of the autonomous vehicle more than 90 degree.

Requirement 2, the closest distance between the feasible path and the third path is equal to or greater than a distance threshold.

A feasible path may obtained by the following ways. Motion planner 330 obtains a possible path set that includes all of possible paths according to the meticulous grained state information of the autonomous vehicle, the first next waypoint and without considering any other vehicles travelling on the road. Then motion planner 330 selects one path from the possible path set, then judges whether the selected path meets the above two requirements. If the selected path meets the above two requirements, the selected path is the feasible path; if the selected path does not meet the above two requirements, motion planner 330 selects another path from the possible path set until the last path in the possible path set has been selected. When the last path in the possible path set has been selected and none of the possible path meets the above two requirements, the computing device determines the feasible path of the autonomous vehicle does not exist.

If the feasible path exists, the computing device implements operations 921 to 922. If the feasible path does not vehicle exist, the computing device implements operation 923.

In operation 921, the computing device sets the information of the feasible path as the information of the forth path. Thus, the computing device generates the information of the forth path.

In operation 922, the computing device calculates a second cost value that indicates amount of resource to be consumed by the autonomous vehicle if the autonomous vehicle needs to adjust movement of the autonomous vehicle along the forth path. Alternatively, the computing device calculates the second cost value according to a plurality of parameters, e.g., the length of the forth path, the period will be spent on moving along the forth path, or the energy will be spend on moving along the forth path.

In the situation of the second cost value is equal to or smaller than the first cost valued, the autonomous vehicle adjusts the movement according to the feasible path obtained in operation 920 to enable the third path can be implemented by the target vehicle without crashing with the autonomous vehicle.

In operation 923, the computing device sets a pre-set cost value MAX as the second cost value.

In operation 930, the computing device determines a fall back path from the current position of the autonomous vehicle to the first next waypoint. The fall back path is calculated according to the meticulous grained state information of the autonomous vehicle, the first next waypoint, the information of the third path returned from the target vehicle, and a preset distance value. The fall back path meets the following to requirements.

Requirement 1, the fall back path include opposite direction movement.

Requirement 2, the closest distance between the fall back path and the third path is equal to or greater than a distance threshold.

During the autonomous vehicle moves along the fall back path, the autonomous vehicle will arrive at a position where the third path is enabled.

In operation 931, the computing device sets the information of the fall back path as the information of the forth path. Thus, the computing device generates the information of the forth path.

In operation 932, the computing device calculates the second cost value. The second cost value indicates amount of resources to be consumed by the autonomous vehicle if the autonomous vehicle needs to adjust the movement of the autonomous vehicle along the forth path to enable the third path.

In a situation of the second cost value is equal to or smaller than the first cost valued, the autonomous vehicle adjusts the movement according to the fall back path obtained in operation 930 to enable the third path can be implemented by the target vehicle without crashing with the autonomous vehicle.

According to the illustration of FIG. 9, the computing device can calculate the second cost value based on the information of the third path returned from the target vehicle.

Furthermore, the process flow of the calculation process as illustrated by FIG. 9 can be simplified by the following ways. The autonomous vehicle and the target vehicle follow a same set policy, where the policy indicates that the target vehicle does not need to return the information of the third path when the autonomous vehicle and the target vehicle moving on a same direction; the target vehicle need to return the information of the third path when the autonomous vehicle and the target vehicle moving on a different direction.

According to the policy, after operation 800, when the computing device determines that the target vehicle does not return information of a third path, the computing device may achieve the determination result that the autonomous vehicle and the target vehicle moving on a same direction directly, and implements operation 820. When the computing device determines that the target vehicle returns information of a third path, the computing device can achieve the determination result that the autonomous vehicle and the target vehicle moving on a different direction directly, and implements operation 930 directly.

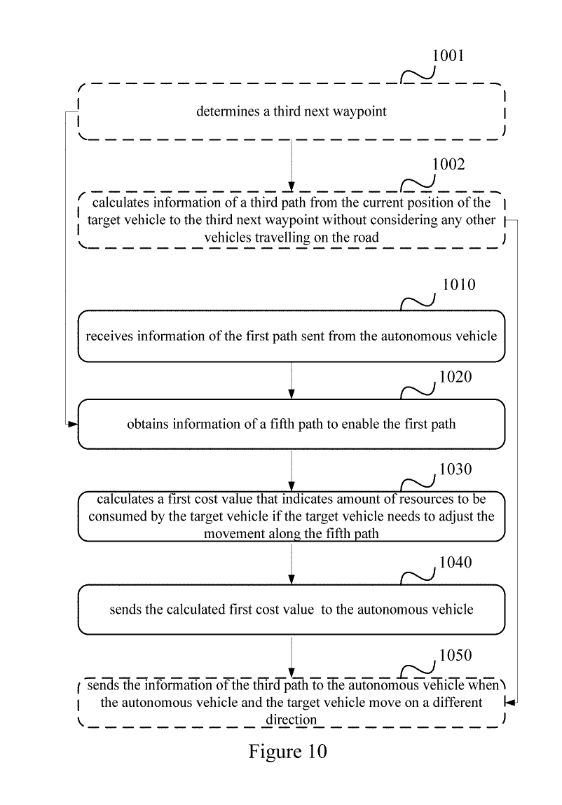

FIG. 10 is a flow diagram illustrating a communication method used by a vehicle in accordance with one embodiment of the present disclosure. The vehicle in this embodiment takes a role as the target vehicle in the above embodiment, such as embodiment description for FIG. 3, FIG. 4, FIG. 5, FIG. 6, FIG. 7, FIG. 8A, FIG. 8B, and FIG. 9. In order to facilitate understanding, the vehicle in this embodiment is called as “target vehicle”. The communication method is implemented by a computing device in the target vehicle. The computing device in the target vehicle may have the similar structure as computer device 300 shown in FIG. 3. The communication method includes following operations.

In operation 1010, the computing device of the target vehicle receives information of a first path sent from the autonomous vehicle. The information of the first path may be received by the computing device of the target through a wireless communication interface, e.g., wireless communication interface 303 in FIG. 3. More detail about the information of the first path can be found at the embodiment description for FIG. 5 and FIG. 7. The computing device of the target vehicle implements operation 1020 after operation 1010. In one embodiment, the computing device of the target vehicle may perform operation 1001 before operation 1020.

In operation 1001, the computing device of the target vehicle determines a next waypoint of the target vehicle using the similar method as described in operations 501˜502 of FIG. 5. In order to distinguish to the motion information cited in the above embodiment, the next waypoint generated by the target vehicle in this step is named as “the third next waypoint”.

In one embodiment, the computing device of the target vehicle may perform operation 1002 after operation 1001.

In operation 1002, the computing device of the target vehicle calculates information of a path from the current position of the target vehicle to the third next waypoint without considering any other vehicles travelling on the road. In order to distinguish to the motion information cited in the above embodiment. The path in this step is named as a “third path”, and the information of third path generated in this step is named as “the information of the third path”. The computing device of the target vehicle uses the similar method as described in operation 503 of FIG. 5 to generate the information of the third path.

In operation 1020, the computing device of the target vehicle obtains information of a fifth path to enable the first path. The fifth path starts with a current position of the target vehicle and ends with the third next waypoint. The information of a fifth path includes a plurality of poses, each pose of the plurality of poses in the information of the fifth path has a position value, a speed of the target vehicle, and a movement direction of the target vehicle. A closest distance between the first path and the fifth path is equal to or greater than a distance threshold. The fifth path is generated by the computing device of the target vehicle according to the similar method as the embodiment description for FIG. 9.

Alternatively, the computing device of the target vehicle determines whether the autonomous vehicle and the target vehicle moving on a same direction firstly. When the autonomous vehicle and the target vehicle moving on a same direction, the computing device of the target vehicle calculates the fifth path as a feasible path. When the autonomous vehicle and the target vehicle moving on a different direction, the computing device of the target vehicle calculates the fifth path as a fall back path. More detail about the calculation may be referred to the embodiment description for FIG. 9.

In operation 1030, the computing device of the target vehicle calculates a first cost value that indicates amount of resources to be consumed by the target vehicle if the target vehicle needs to adjust the movement along the fifth path. The method used by the computing device of the target vehicle to calculate a first cost value is similar to the method for calculating the second cost that is discussed by the embodiment description for FIG. 8A, FIG. 8A, and FIG. 9.

In operation 1040, the computing device of the target vehicle sends the calculated first cost value in operation 1030 to the autonomous vehicle.

Alternatively, the computing device of the target vehicle implements operation 1050.

Operation 1050, the computing device of the target vehicle sends the information of the third path to the autonomous vehicle when the autonomous vehicle and the target vehicle move on a different direction.

The following section of the embodiment provides three examples.

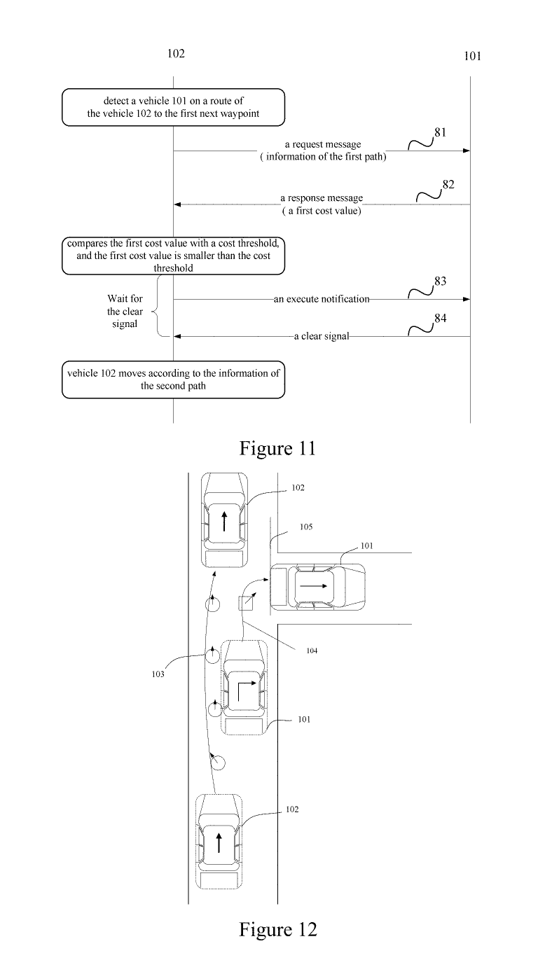

FIG. 11 is a simplified diagram showing a communication process of two vehicles in a scenario similar to FIG. 1. In a scenario where two vehicles traveling in the same the direction in a lane, vehicles 102 in FIG. 11 and FIG. 12 stand for an autonomous vehicle equipped with a computing device, e.g., computing device 300 in FIG. 3. Vehicles 101 in FIG. 11 and FIG. 12 stand for another vehicle, a computing device in vehicle 101 may receive and interpret information of first path sent from vehicle 102, may return a first cost value, may receive and interpret notifications sent from vehicle 102, and may execute actions according to the notifications and the signals.

FIG. 12 is a diagram showing the movements of two vehicles. Path 103 in FIG. 12 stands for the first path in FIG. 5, FIG. 8A, FIG. 8B, FIG. 9 and FIG. 10. Path 104 in FIG. 12 stands for the third path in FIG. 5, FIG. 8A, FIG. 8B, FIG. 9 and FIG. 10. Vehicles that drew with dashed lines stands for the original location of the vehicles. Vehicles that drew with real lines stand for the location of the vehicles after movement.

Vehicle 102 detects vehicle 101 on a route of vehicle 102 to the first next waypoint. Vehicle 102 sends request message 81 carrying the information of the first path to vehicle 101. Vehicle 101 returns response message 82 carrying first cost value to the vehicle 102. Vehicle 102 compares the first cost value with a cost threshold, and determines the first cost value is smaller than the cost threshold. Vehicle 102 sets the information of the first path as information of the second path and sends an execute notification 83 to vehicle 101. Vehicle 102 waits for a clear signal.

Vehicle 101 moves according to the information of the third path after vehicle 101 receives the execute notification. During the movement, vehicle 101 determines whether the first path is enabled according to the information of the first path carried in request message 81. As illustrated in FIG. 12, at position 105, vehicle 101 determines that the first path is enabled. Vehicle 101 sends a clear signal 84 to the vehicle 102 when the first path is enabled.

After vehicle 102 receives the clear signal 84, vehicle 102 moves along the second path according to the information of the second path. In this example, the second path is same to the first path.

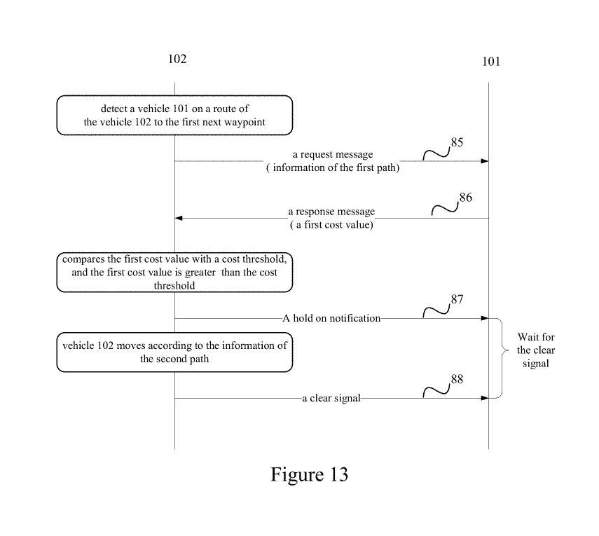

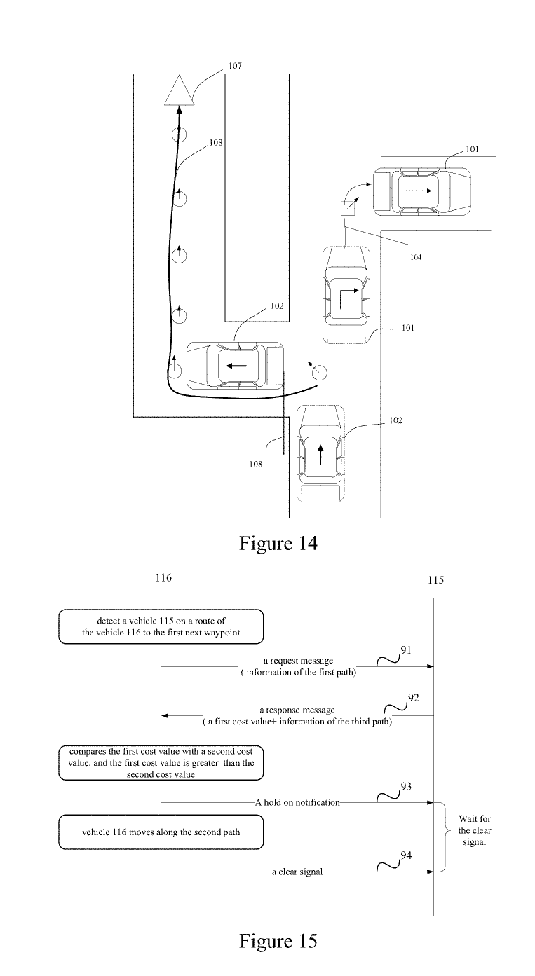

FIG. 13 is a simplified diagram showing a communication process of two vehicles in a scenario similar to FIG. 1. In a scenario where two vehicles traveling in the same the direction in a lane, vehicles 102 in FIG. 13 and FIG. 14 stand for an autonomous vehicle equipped with a computing device, e.g., computing device 300 in FIG. 3. Vehicles 101 in FIG. 13 and FIG. 14 stand for another vehicle, a computing device in vehicle 101 may receive and interpret information of first path sent from vehicle 102, may return a first cost value, may receive and interpret notifications sent from vehicle 102, and may execute actions according to the notifications and the signals.

FIG. 14 is a diagram showing the movements of the two vehicles. Path 108 in FIG. 14 stands for the second path in FIG. 5, FIG. 8A, FIG. 8B, and FIG. 9. Path 104 in FIG. 12 stands for the third path in FIG. 5, FIG. 8A, FIG. 8B, and FIG. 9. Vehicles that drew with dashed lines stands for the original location of the vehicles. Vehicles that drew with real lines stands for the location of the vehicles after movement.

Vehicle 102 detects vehicle 101 on a route of autonomous vehicle 102 to the first next waypoint. Vehicle 102 sends request message 85 carrying the information of the first path to vehicle 101. Vehicle 101 returns response message 86 carrying first cost value to the vehicle 102. Vehicle 102 compares the first value with a cost threshold, and determines the first cost value is greater than the cost threshold. Vehicle 102 calculates a second next waypoint 107 and the information of a path from the current position of vehicle 102 to the second next waypoint. Waypoint 107 in FIG. 14 stands for the second next waypoint. Path 108 in FIG. 14 stands for the path from the current position of vehicle 102 to the waypoint 107.

Vehicle 102 moves according to information of path 108 and sends hold on notification 87 to vehicle 101.

Vehicle 101 stays at the current position and waiting for the clear signal 88 after vehicle 101 receives the hold on notification 87.

During the movement, vehicle 102 determines whether the current position of vehicle 101 is enabled. As illustrated in FIG. 14, at position 108, vehicle 102 determines that the current position of vehicle 101 is enabled. Vehicle 102 sends a clear signal 88 to vehicle 101 when the current position of vehicle 101 is enabled.

After vehicle 101 receives clear signal 88, vehicle 101 continue to move along path 104.

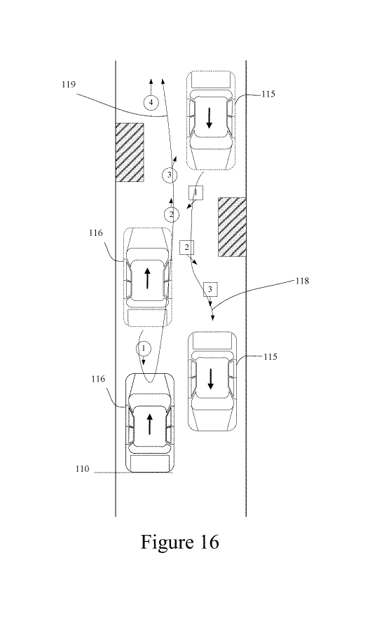

FIG. 15 is another simplified diagram showing a communication process of two vehicles in a scenario similar to FIG. 2. In a scenario of two vehicles traveling in opposite directions in a narrow lane without any lane markers, vehicles 116 in FIG. 15 and FIG. 16 stand for an autonomous vehicle that equipped a computing device, e.g., computing device 300 in FIG. 3. Vehicles 115 in FIG. 15 and FIG. 16 stand for another vehicle, a computing device in vehicle 115 may receive and interpret a request message sent from vehicle 116, may return a response message, may receive and interpret notifications sent from vehicle 116, and may execute actions according to the notifications and the signals.

FIG. 16 is a diagram showing the movements of two vehicles. Vehicles that drew with dashed lines stand for the original location of the vehicles. Vehicles that drew with real lines stand for the location of the vehicles after movement.

When vehicle 116 detects vehicle 115 is on a route of vehicle 116 to the first next waypoint, vehicle 116 sends request message 91 carrying information of the first path of vehicle 116 to vehicle 115. Vehicle 115 returns response message 92 carrying first cost value and information of the third path to the vehicle 116. Path 118 in FIG. 16 stands for the third path in FIG. 5, FIG. 8A, FIG. 8B, and FIG. 9.

Vehicle 116 calculates a second cost value, where the second cost value indicates resource quantity that will be consumed by the autonomous vehicle to adjust movement along the second path to enable the third path. Path 119 in FIG. 16 stands for the second path in FIG. 5, FIG. 8A, FIG. 8B, and FIG. 9. Vehicle 116 compares the first cost value with the second cost value, and determines that the first cost value is greater than the second cost value. Vehicle 116 sends hold on notification 93 to vehicle 115. On the side of vehicle 116, vehicle 116 adjusts the movement along path 119 to enable the third path. During the movement, vehicle 116 determines whether the third path is enabled. As illustrated in FIG. 16, at position 110, vehicle 116 determines that path 118 is enabled. Vehicle 116 sends a clear signal 94 to vehicle 115 when path 118 is enabled. On the side of vehicle 115, vehicle 115 stays on the current position after vehicle 115 receives hold on notification 93 and waits for clear signal 94. Vehicle 115 begins to move along the path 118 after receive clear signal 94.

While several embodiments have been provided in the present disclosure, it should be understood that the disclosed methods and devices might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A motion controlling method for an autonomous vehicle, comprising:
obtaining, by a computing device of the autonomous vehicle, information of a first path from a current position of the autonomous vehicle to a first next waypoint, wherein the information of the first path comprises a plurality of poses, each of the plurality of poses includes a position of the autonomous vehicle in the first path, a speed of the autonomous vehicle, and a movement direction of the autonomous vehicle;
identifying, by one or more sensors of the autonomous vehicle, a target vehicle occupying the first path according to the information of the first path;
sending, by the computing device of the autonomous vehicle, the information of the first path to the target vehicle;
receiving, by the computing device of the autonomous vehicle, a first cost value sent from the target vehicle, wherein the first cost value indicates amount of resources to be consumed by the target vehicle if the target vehicle needs to adjust movement of the target vehicle to enable the first path;
generating, by the computing device of the autonomous vehicle, information of a second path that starts with the current position of autonomous vehicle based on the first cost value; and
moving, by the computing device of the autonomous vehicle, the autonomous vehicle along the second path based on the information of the second path.

2. The method according to claim 1, the method further comprises:
receiving, by the computing device of the autonomous vehicle, information of a third path sent from the target vehicle before the generating step, wherein the third path starts with a current position of the target vehicle;
wherein the generating step comprises:
calculating, by the computing device of the autonomous vehicle, a second cost value, wherein the second cost value indicates amount of resources to be consumed by the autonomous vehicle if the autonomous vehicle needs to adjust movement of the autonomous vehicle to enable the third path;
setting the information of the first path as the information of the second path when the first cost value is smaller than the second cost value;
wherein the moving step comprises:
waiting for, by the computing device of the autonomous vehicle, a clear signal sent from the target vehicle, wherein the clear signal indicates the first path has been enabled;
moving, by the computing device of the autonomous vehicle, the autonomous vehicle based on the information of the second path after the computing device of the autonomous vehicle receives the clear signal.

3. The method according to claim 2, wherein the calculating step comprises:
determining, by the computing device of the autonomous vehicle, whether the autonomous vehicle and the target vehicle moving on a same direction;
when the autonomous vehicle and the target vehicle moving on a same direction:
determining, by the computing device of the autonomous vehicle, whether a feasible path from the current position of the autonomous vehicle to the first next waypoint exist, wherein the feasible poses does not include a opposite direction movement and a closest distance between the feasible path to the third path is equal to or greater than a distance threshold;
when the feasible path exists:
calculating, by the computing device of the autonomous vehicle, the second cost value that indicates amount of resource to be consumed by the autonomous vehicle if the autonomous vehicle needs to adjust movement of the autonomous vehicle along the feasible path.

4. The method according to claim 2, wherein the calculating second cost value comprises:
determining, by the computing device of the autonomous vehicle, whether the autonomous vehicle and the target vehicle moving on a same direction;
when the autonomous vehicle and the target vehicle moving on a same direction:
determining, by the computing device of the autonomous vehicle, whether a feasible path from the current position of the autonomous vehicle to the first next waypoint exist, wherein the feasible path does not include a opposite direction movement and a closest distance between the feasible path to the third path is equal to or greater than a distance threshold;
setting, by the computing device of the autonomous vehicle, a pre-set cost value as the second cost value when the feasible path does not exist.

5. The method according to claim 2, wherein the calculating second cost value comprises:
determining, by the computing device of the autonomous vehicle, whether the autonomous vehicle and the target vehicle moving on a same direction;
when the autonomous vehicle and the target vehicle moving on a different direction:
determining, by the computing device of the autonomous vehicle, a fall back path from the current position of the autonomous vehicle to the first next waypoint, wherein the fall back path include a opposite direction movement and a closest distance of the fall back path and the third path is equal to or greater than the preset distance value;
calculating, by the computing device of the autonomous vehicle, the second cost value as amount of resource to be consumed by the autonomous vehicle if the autonomous vehicle needs to adjust movement of the autonomous vehicle along the fall back path.

6. The method according to claim 2, wherein the calculating second cost value comprises:
determining, by the computing device of the autonomous vehicle, a fall back path from the current position of the autonomous vehicle to the first next waypoint, wherein the fall back path include a opposite direction movement and a closest distance of the fall back path and the third path is equal to or greater than the preset distance value;
calculating, by the computing device of the autonomous vehicle, the second cost value as amount of resource to be consumed by the autonomous vehicle if the autonomous vehicle needs to adjust movement of the autonomous vehicle along the fall back path.

7. The method according to claim 1, the method further comprises:
receiving, by the computing device of the autonomous vehicle, information of a third path sent from the target vehicle before the generating step, wherein the third path from a current position of the target vehicle;
wherein the generating step comprises:
calculating, by the computing device of the autonomous vehicle, a second cost value, wherein the second cost value indicates amount of resources to be consumed by the autonomous vehicle if the autonomous vehicle needs to adjust movement of the autonomous vehicle along a forth path to enable the third path, wherein the forth path starts with the current position of the autonomous vehicle and ends with the first next waypoint;
setting, by the computing device of the autonomous vehicle, information of the forth path as the information of the second path when the first cost value is equal to or greater than the second cost value;
wherein the moving step comprises:
moving, by the computing device of the autonomous vehicle, the autonomous vehicle based on the information of the second path;
sending, by the computing device of the autonomous vehicle, a clear signal to the target vehicle, wherein the clear signal indicates the third path has been enabled.

8. The method according to claim 7, wherein the calculating the second cost value comprises:
determining, by the computing device of the autonomous vehicle, whether the autonomous vehicle and the target vehicle moving on a same direction;
when the autonomous vehicle and the target vehicle moving on a same direction:
determining, by the computing device of the autonomous vehicle, whether a feasible path from the current position of the autonomous vehicle to the first next waypoint exist, wherein the feasible poses meet two requirements: the feasible path does not include a opposite direction movement, and a closest distance between the feasible path to the third path is equal to or greater than a distance threshold;
when the feasible path exists:
calculating, by the computing device of the autonomous vehicle, the second cost value as amount of resource to be consumed by the autonomous vehicle if the autonomous vehicle needs to adjust movement of the autonomous vehicle along the feasible path;
setting, by the computing device of the autonomous vehicle, information of the feasible path as the information of the forth path.

9. The method according to claim 7, wherein the calculating second cost value comprises:
determining, by the computing device of the autonomous vehicle, whether the autonomous vehicle and the target vehicle moving on a same direction;
when the autonomous vehicle and the target vehicle moving on a different direction:
determining, by the computing device of the autonomous vehicle, a fall back path from the current position of the autonomous vehicle to the first next waypoint, wherein the fall back path include a opposite direction movement and a closest distance of the fall back path and the third path is equal to or greater than the preset distance value;
calculating, by the computing device of the autonomous vehicle, the second cost value as amount of resource to be consumed by the autonomous vehicle if the autonomous vehicle needs to adjust movement of the autonomous vehicle along the fall back path;
setting, by the computing device of the autonomous vehicle, information of the fall back path as the information of the forth path.

10. The method according to claim 7, wherein the calculating second cost value comprises:
determining, by the computing device of the autonomous vehicle, a fall back path from the current position of the autonomous vehicle to the first next waypoint, wherein the fall back path include a opposite direction movement and a closest distance of the fall back path and the third path is equal to or greater than the preset distance value;
calculating, by the computing device of the autonomous vehicle, the second cost value as amount of resource to be consumed by the autonomous vehicle if the autonomous vehicle needs to adjust movement of the autonomous vehicle along the fall back path;
setting, by the computing device of the autonomous vehicle, information of the fall back path as the information of the forth path.

11. The method according to claim 1, wherein the generating step comprises:
setting the information of the first path as the information of the second path when the first cost value is smaller than a cost threshold;
the moving step comprises:
waiting for, by the computing device of the autonomous vehicle, a clear signal sent from the target vehicle, wherein the clear signal indicates the first path has been enabled;
moving, by the computing device of the autonomous vehicle, the autonomous vehicle based on the information of the second path after the computing device of the autonomous vehicle receives the clear signal.

12. The method according to claim 1, the generating step comprises:
when the first cost value is equal to or greater than a cost threshold:
determining, by the computing device of the autonomous vehicle, a second next waypoint;
calculating, by the computing device of the autonomous vehicle, information of a path from the current position of autonomous vehicle to the second next waypoint;
setting, by the computing device of the autonomous vehicle, information of the path from the current position of autonomous vehicle to the second next waypoint as the information of the second path;
the moving step comprises:
moving, by the computing device of the autonomous vehicle, the autonomous vehicle based on the information of the second path;
sending, by the computing device of the autonomous vehicle, a clear signal to the target vehicle, wherein the clear signal indicates a current position of the target vehicle has been enabled.

13. A communication method for an autonomous vehicle, comprising:
receiving, by a computing device of a target vehicle, information of a first path sent from an autonomous vehicle, wherein the information of the first path comprises a plurality of poses, each pose of the plurality of poses includes a position of the autonomous vehicle in the first path, a speed of the autonomous vehicle, and a movement direction of the autonomous vehicle;
obtaining, by the computing device of the target vehicle, information of a second path from a current position of the target vehicle to a next waypoint, wherein a closest distance between the first path and the second path is equal to or greater than a distance threshold;
calculating, by the computing device of the target vehicle, a cost value that indicates amount of resources to be consumed by the target vehicle if the target vehicle needs to adjust the movement along the second path;
sending, by the computing device of the target vehicle, the cost value to the autonomous vehicle.

14. The method according to claim 13, further comprising:
calculating, by the computing device of the target vehicle, information of a third path from the current position of the target vehicle to the next waypoint without considering any other vehicles travelling on the road;
sending, by the computing device of the target vehicle, information of the third path to the autonomous vehicle.

15. The method according to claim 14, before sending the information of the third path to the autonomous vehicle, the method further comprising:
determining, by the computing device of the target vehicle, the autonomous vehicle and the target vehicle moving on a different direction.

16. A computing device for controlling the movement of an autonomous vehicle, the computing device is communicative coupled with the autonomous vehicle, the computing device comprising:
a memory comprising instructions; and
one or more processors in communication with the memory, wherein the one or more processors execute the instructions to:
obtain information of a first path from a current position of the autonomous vehicle to a first next waypoint, wherein the information of the first path comprises a plurality of poses, each of the plurality of poses includes a position of the autonomous vehicle in the first path, a speed of the autonomous vehicle, and a movement direction of the autonomous vehicle;
identify a target vehicle occupying the first path according to the information of the first path;
send the information of the first path to the target vehicle;
receive a first cost value sent from the target vehicle, wherein the first cost value indicates amount of resources to be consumed by the target vehicle if the target vehicle needs to adjust movement of the target vehicle to enable the first path;
generate information of a second path that starts with the current position of autonomous vehicle based on the first cost value; and
move the autonomous vehicle along the second path based on the information of the second path.

17. The computing device according to claim 16, the instructions further cause the one or more processors to:
receive information of a third path sent from the target vehicle before generate the information of a second path, wherein the third path starts with a current position of the target vehicle;
wherein generate the information of a second path comprises:
calculate a second cost value, wherein the second cost value indicates amount of resources to be consumed by the autonomous vehicle if the autonomous vehicle needs to adjust movement of the autonomous vehicle to enable the third path;
set the information of the first path as the information of the second path when the first cost value is smaller than the second cost value;
wherein move the autonomous vehicle along the second path comprises:
wait for a clear signal sent from the target vehicle, wherein the clear signal indicates the first path has been enabled;
move the autonomous vehicle based on the information of the second path after the computing device of the autonomous vehicle receives the clear signal.

18. The computing device according to claim 17, wherein calculate the second cost value comprises:
determine whether the autonomous vehicle and the target vehicle moving on a same direction;
when the autonomous vehicle and the target vehicle moving on a same direction:
determine whether a feasible path from the current position of the autonomous vehicle to the first next waypoint exist, wherein the feasible poses does not include a opposite direction movement and a closest distance between the feasible path to the third path is equal to or greater than a distance threshold;
when the feasible path exists:
calculate the second cost value that indicates amount of resource to be consumed by the autonomous vehicle if the autonomous vehicle needs to adjust movement of the autonomous vehicle along the feasible path.

19. The computing device according to claim 17, wherein calculate a second cost value comprises:
determine whether the autonomous vehicle and the target vehicle moving on a same direction;
when the autonomous vehicle and the target vehicle moving on a same direction:
determine whether a feasible path from the current position of the autonomous vehicle to the first next waypoint exist, wherein the feasible path does not include a opposite direction movement and a closest distance between the feasible path to the third path is equal to or greater than a distance threshold;
set a pre-set cost value as the second cost value when the feasible path does not exist.

20. The computing device according to claim 17, wherein calculate a second cost value comprises:
determine whether the autonomous vehicle and the target vehicle moving on a same direction;
when the autonomous vehicle and the target vehicle moving on a different direction:
determine a fall back path from the current position of the autonomous vehicle to the first next waypoint, wherein the fall back path include a opposite direction movement and a closest distance of the fall back path and the third path is equal to or greater than the preset distance value;
calculate the second cost value as amount of resource to be consumed by the autonomous vehicle if the autonomous vehicle needs to adjust movement of the autonomous vehicle along the fall back path.

21. The computing device according to claim 16, the instructions further cause the one or more processors to:
receive information of a third path sent from the target vehicle before the generating step, wherein the third path from a current position of the target vehicle;
wherein generate the information of a second path comprises:
calculate a second cost value, wherein the second cost value indicates amount of resources to be consumed by the autonomous vehicle if the autonomous vehicle needs to adjust movement of the autonomous vehicle along a forth path to enable the third path, wherein the forth path starts with the current position of the autonomous vehicle and ends with the first next waypoint;
set information of the forth path as the information of the second path when the first cost value is equal to or greater than the second cost value;
wherein move the autonomous vehicle along the second path comprises:
move the autonomous vehicle based on the information of the second path;
send a clear signal to the target vehicle, wherein the clear signal indicates the third path has been enabled.

22. The computing device according to claim 21, wherein calculate the second cost value comprises:
determine whether the autonomous vehicle and the target vehicle moving on a same direction;
when the autonomous vehicle and the target vehicle moving on a same direction:
determine whether a feasible path from the current position of the autonomous vehicle to the first next waypoint exist, wherein the feasible poses meet two requirements: the feasible path does not include a opposite direction movement, and a closest distance between the feasible path to the third path is equal to or greater than a distance threshold;
when the feasible path exists:
calculate the second cost value as amount of resource to be consumed by the autonomous vehicle if the autonomous vehicle needs to adjust movement of the autonomous vehicle along the feasible path;
sett information of the feasible path as the information of the forth path.

23. The computing device according to claim 21, wherein calculate the second cost value comprises:
determine whether the autonomous vehicle and the target vehicle moving on a same direction;
when the autonomous vehicle and the target vehicle moving on a different direction:
determine a fall back path from the current position of the autonomous vehicle to the first next waypoint, wherein the fall back path include a opposite direction movement and a closest distance of the fall back path and the third path is equal to or greater than the preset distance value;
calculate the second cost value as amount of resource to be consumed by the autonomous vehicle if the autonomous vehicle needs to adjust movement of the autonomous vehicle along the fall back path;
sett information of the fall back path as the information of the forth path.

24. The computing device according to claim 17, wherein generate the information of a second path comprises:
set the information of the first path as the information of the second path when the first cost value is smaller than a cost threshold;
wherein move the autonomous vehicle along the second path comprises:
wait for a clear signal sent from the target vehicle, wherein the clear signal indicates the first path has been enabled;
move the autonomous vehicle based on the information of the second path after the computing device receives the clear signal.

25. The computing device according to claim 17, wherein generate the information of a second path comprises:
when the first cost value is equal to or greater than a cost threshold:
determine a second next waypoint;
calculate information of a path from the current position of autonomous vehicle to the second next waypoint;
set information of the path from the current position of autonomous vehicle to the second next waypoint as the information of the second path;
wherein move the autonomous vehicle along the second path comprises:
move the autonomous vehicle based on the information of the second path;
send a clear signal to the target vehicle, wherein the clear signal indicates a current position of the target vehicle has been enabled.

26. A computing device that is communicative coupled with a target vehicle, the computer device comprising:
a memory comprising instructions; and
one or more processors in communication with the memory, wherein the one or more processors execute the instructions to:
receive information of a first path sent from an autonomous vehicle, wherein the information of the first path comprises a plurality of poses, each pose of the plurality of poses includes a position of the autonomous vehicle in the first path, a speed of the autonomous vehicle, and a movement direction of the autonomous vehicle;
obtain information of a second path from a current position of the target vehicle to a next waypoint, wherein a closest distance between the first path to the second path is equal to or greater than a distance threshold;
calculate a cost value that indicates amount of resources to be consumed by the target vehicle if the target vehicle needs to adjust the movement along the second path;
send the cost value to the autonomous vehicle.
